(19) United States
(12) Patent Application Publication
(10) Pub. No.: US 2011/0244419 A1
(43) Pub. Date: Oct. 6, 2011

(54) MEDICAL INSTRUMENT ASSEMBLY AND A METHOD OF MANUFACTURING THE SAME

(75) Inventor: Klas Tofft, Lidingo (SE)

(73) Assignee: TOFFT PROMOTION AKTIEBOLAG, Kista (SE)

(21) Appl. No.: 13/162,146

(22) Filed: Jun. 16, 2011

Related U.S. Application Data
(63) Continuation-in-part of application No. PCT/SE2009/051454, filed on Dec. 18, 2009.

(30) Foreign Application Priority Data
Dec. 19, 2008 (SE) 0850166-0

(51) Int. Cl. A61C 5/02; B22F 1/00; B22F 3/12

(52) U.S. Cl. 433/102; 433/224; 419/38

(57) ABSTRACT

To reduce the production costs for medical instruments (preferably endodontic root canal files) and increase their attractiveness to dentists/doctors, a medical instrument assembly is provided, which is made by metal injection molding and comprises at least two medical instruments (1-6) and a runner (7a, 7b) that interconnects said at least two medical instruments (1-6) and is formed integrally therewith. Each of the at least two medical instruments (1-6) have a grip portion (13-15; 23-25) at a distal end that offers a grip for a hand or a tool such as a dental hand-piece, and each of the medical instruments (1-6) is removable from the runner (7a, 7b) by breaking it away from the runner (7a, 7b), irrespective of an adjacent medical instrument. The medical instruments may be of the same or of different size, may be disposable, and the assembly preferably is sterile and contained in a closed sterile package. In a preferred embodiment, the cutting portion (20) of at least one of the endodontic root canal files (1-6) has a plurality of straight cutting edges (21, 21′). It is a matter of course, that the special profile for the endodontic instrument with straight cutting edges may be used also for instruments that are manufactured as individual pieces, i.e. without a runner that interconnects the endodontic instrument to another endodontic instrument.

### CROSS-REFERENCE TO RELATED APPLICATIONS

This application is a Continuation-In-Part of International Application No. PCT/SE2009/051454, filed 18 Dec. 2009. This application also claims foreign priority under 35 U.S.C. 119 to Swedish Patent Application No. 0850166-0, filed 19 Dec. 2008. The complete disclosures of these applications are incorporated herein by reference.

### TECHNICAL FIELD

The present invention relates to a medical instrument assembly made by metal injection molding (MIM) and to a method of manufacturing such a medical instrument assembly by MIM technology.

The present invention also relates to a metal injection molded endodontic instrument.

The present invention also relates to a method of cleaning a root canal of a tooth, in particular an apical portion of a root canal of a tooth.

Metal injection molding is a manufacturing process which combines the versatility of plastic injection molding with the strength and integrity of machined, forged, cast or otherwise manufactured small, complex, metal parts. The process involves combining fine metal powders or mixture of metal powder with plastic binders, which allow the metal powder to be injected into a mold using injection molding machines. After the molding of the part but before the binders are removed, the part is referred to as a “green part” or “green body”. The next step is to remove the binders with solvents and/or thermal processes. The resultant metal part is sintered at temperatures high enough to sinter the particles to each other. The products of metal injection molding can be obtained as high as 98% or sometimes even close to 100% of their theoretical density. Tolerances as small as ±0.003 mm per linear mm can usually be held without secondary machining or cold forming processes.

### BACKGROUND ART

Endodontic instruments are used by dentists and endodontists in endodontic therapy, i.e. a sequence of treatment for the pulp of a tooth, whose end result is the elimination of infection and protection of the decontaminated tooth from future microbial invasion. Root canals and their associated pulp chamber are the anatomical hollows within a tooth which are naturally inhabited by nerve tissue, blood vessels and a number of other cellular entities, and endodontic therapy includes the complete removal of these structures, the subsequent cleaning, shaping and decontamination of these hollows with the use of tiny files and irrigating solutions and the filling of the decontaminated root canals with an inert filling. To cure an infected tooth and save the tooth, the dentist drills into the pulp chamber and removes the infected pulp by scraping it out of the root canals. The instrument used for scraping usually is called a root canal file or broach file and is tapered and has a helical cutting edge along the tapered portion. When performing the endodontic therapy, widely called “root canal”, the dentist has to use a series of various sizes of root canal files, often as many as 4-10 files for each root, and the used files have to be carefully sterilized in autoclaves in order not to risk transferring some infection (e.g. human immunodeficiency virus, HIV) to a subsequent patient when the root canal files are used once more.

In U.S. Pat. No. 5,655,950 a method of fabricating an endodontic instrument by a machining operation is disclosed. A wire-like runner composed of a titanium alloy is advanced past a rotating grinding wheel at a relatively slow feed rate, with a sufficient depth of cut to remove all of the material on a given surface without over grinding a previously ground surface, and with the grinding wheel rotating at a relatively slow surface speed. The disclosed method is stated to be able to efficiently produce endodontic instruments having a high degree of flexibility, high resistance to torsion breakage, and with sharp cutting edges along the working length.

WO 2006/091751 A2 discloses a cold forming method of forming endodontic instruments, such as files, from blank metal thread or wire by using a roll forming apparatus that includes dies having a negative impression of a cutting edge. Even though roll forming may be a faster process than abrasive cutting of the cutting edge, it is a relatively time consuming production method. Preferred materials are stainless steels alloys for their relatively low cost, good performance and biological inertness, and titanium based alloys, such as nickel titanium, for their strength and flexibility.

The manufacture of unitary, one-piece plastic endodontic micro-brushes by injection molding is described in U.S. Pat. No. 6,981,869 B2. No details about the injection molding are disclosed.

In US 2002/0006599 A1 there is disclosed a break-resistant composite endodontic instrument having a core of twisted fibers covered by a polymer with embedded abrasive particles.

US 2006/0185170 A1 discloses the suggestion to use the MIM manufacturing process for making endodontic instruments from powdered materials. Like above, preferred materials are stainless steels alloys for their relatively low cost, good performance and biological inertness, and titanium based alloys, such as nickel titanium, for their strength and flexibility. However, no endodontic instruments manufactured by MIM technology appear to be available on the market.

US 2007/0009850 A1 discloses methods for apical preparation using endodontic instruments made of super-elastic alloys. The apical third of a root canal is cleaned and/or shaped during a root canal procedure with an endodontic file made from a titanium-based alloy either by reciprocating manual use or by using a reciprocating powered hand piece. The titanium-based endodontic file has super-elastic properties that allow it to be very flexible and strong. The endodontic file is rotated in the apex of a root canal in degrees of rotation less than 120 degrees. By restricting the degree of rotation, excessive cutting by the endodontic file is kept to a minimum. The use of elastic alloys of titanium, e.g. NiTi, helps prevent ledging or other damage to the root canal wall that may be caused using rigid apical files made of stainless steel. However, NiTi is highly vulnerable to torsional stress and is also vulnerable to cyclic fatigue.

Root canal preparation with only one reciprocating endodontic instrument of nickel-titanium (NiTi) is disclosed in an article published on the Internet, http://www.qedendo.co.uk/acatalog/RECIPROC_-_Canal_preparation_with_only_one_reciprocating_instrument.html.

Other background articles published on the Internet and commenting on the superiority of NiTi files over traditional stainless steel files are http://www.endomail.com/articles/blm27mindsets.html, http://www.endomail.com/articles/blm33deeper.html, and http://endospot.com/201.

See also Roane J B, Sabala C L, Duncanson M G Jr (1985) The ‘balanced force’ concept for instrumentation of curved canals. Journal of Endodontics 11, 203-11.

One problem with endodontic manufacturing processes is that they fail to reduce or sometimes even cause stress fractures or weaknesses in the metal of the file. Even minor imperfections in the metal of an endodontic file can be problematic. Endodontic files are very thin, thus small imperfections such as cracks can cause the file to break during use. A broken file in a root canal is very difficult to remove and can cause damage to the root canal. However, this problem is reduced by the MIM manufacturing process. Endodontic files produced by this process obtain improved mechanical and functional properties.

Another problem is that while current manufacturing methods are capable of producing endodontic files in a variety of different shapes and sizes using a variety of different metals, there is still a great need to reduce the costs of manufacturing endodontic files. Forming an endodontic file from raw materials is a significant expense in the endodontic manufacturing process. A problem here usually is the time it takes to form each piece. Furthermore, the manufacturing equipment must be adjusted to all the different shapes of the files. For example, forming a cutting edge by grinding a metal wire can take more than a minute for each piece and the grinding machine can cost hundreds of thousands of dollars. A problem with the MIM technology is that a high-volume production is necessary to warrant the large investment required, and no endodontic instruments manufactured by MIM technology appear to be available on the market.

Also other medical instruments besides endodontic instruments may be complicated and/or expensive to manufacture.

### OBJECTS OF THE INVENTION

An object of the present invention is to reduce the production costs for medical instruments, particularly dental instruments, and especially endodontic instruments, and increase their attractiveness to the user.

This object is achieved by providing a medical instrument assembly made by metal injection molding and comprising at least two medical instruments and a runner interconnecting said at least two medical instruments and formed integrally therewith, each of said at least two medical instruments having a grip portion at a distal end that offers a grip for a hand or a tool such as a dental hand-piece, and each of said at least two medical instruments being removable from the runner by breaking it away from the runner, irrespective of the other.

The above is particular useful when the medical instruments are endodontic instruments. Hereby, the dentist can connect the hand-piece to the shaft without having to touch the endodontic instrument, which reduces the risk of damaging the endodontic instrument on breaking it away from the runner and attaching it to the hand-piece, preferably an angle hand-piece, more preferably a right angle hand-piece. Alternatively, said at least two endodontic instruments are spaced apart along the runner, so that an arbitrary one of said shafts is readily accessible for gripping by the fingers of the user. This embodiment may be preferred by dentists who feel that their sensitivity is improved by holding the endodontic instrument between his fingers instead of holding a dental hand-piece.

Suitably, the endodontic instrument assembly is such that each of said at least two endodontic instruments is attached to the runner at a position on the shaft towards the cutting portion of the endodontic instrument. Thereby, the upper part of the endodontic instrument is freely accessible and the endodontic instrument can be mounted to a dental hand-piece before removing it from the runner.

In accordance with the present invention, such a medical instrument assembly may be manufactured by means of MIM technology by:

a) providing a mold including a sprue and at least two mold cavities connected via an interconnecting runner, each of the mold cavities at least partially corresponding to or approximating the shape of a medical instrument;
b) injecting a molding material including a metal powder via the sprue and the runner into the mold cavities and solidifying the molding material to form a green body including at least two connected green body portions corresponding to the mold cavities and the connective runner;
c) removing the green body from the mold,
d) debinding the green body,
e) densifying the green body by sintering at a temperature of above 1050° C., preferably above 1150° C., to a final density of more than 90% of the theoretical density, so as to provide a metal structure including at least two interconnected medical instruments corresponding to the shape of the cavities.

In principle, the resulting medical instrument assembly can be manufactured in essentially the time it takes to manufacture a single medical instrument by the MIM technology. Consequently, the production rate is greatly increased and the production cost greatly reduced. The piece price can be so low, that the individual medical instruments of an assembly are disposable, the time and effort of sterilizing used medical instruments is eliminated, as is the possible worry (of both patient and dentist/doctor) that a patient could get infected by an insufficiently sterilized medical instrument.

Suitably, the medical instrument assembly is sterilized and delivered contained in a closed sterile package to be opened before the eyes of a patient.

The above is particular useful when the medical instruments are endodontic instruments. After opening the package, the dentist breaks away a suitable one of the endodontic instruments from the runner of the assembly, when using the crown-down method usually a large one for the wide entrance portion of the tapering root canal. Preferably, the endodontic instruments of the assembly differ from one another in size, so that when the entrance portion of the root canal is treated, the dentist breaks away a thinner endodontic instrument for treating a subsequent narrower portion of the root canal, and so on. Of course, the assembly can have their sizes adapted to other mechanical treatments than the crown-down method.

The assembly suitably comprises more than four, preferably at least six, endodontic instruments of different size and/or taper. Six combinations of size and taper of endodontic instruments usually are sufficient when using the crown-down method. Of course, assemblies with even more endodontic instruments would be possible.

However, in particular when using the crown down method it has been found that three endodontic instruments can be sufficient. A first sized for a coronal portion of the tooth, a second sized for a middle portion of the tooth, and a third for the apical portion of a teeth.

Alternatively, all of the endodontic instruments of the assembly may, if desired, be of the same size and taper.

In a preferred embodiment the metal injection molded endodontic instrument comprises in weight %:
15-30 Cr,
8-16 Ni,
0.01-5 Mo,
0.01-1 Cu,
0.09-1 Mn,
less than 0.14 C,
less than 0.12 O,
balance Fe and incidental impurities; and
   said endodontic instrument having a hardness in the range of 55-75 HRB and a yield strength in the range of 150-240 MPa.

Such a metal injection molded endodontic instrument can be manufactured at a much lower cost than if it should be made of a titanium-based alloy such as NiTi having super-elastic properties, and the endodontic instrument will not be rigid but have the desired flexibility, resilience and strength, and will not be likely to fail during use. NiTi is highly vulnerable to torsional stress and is also vulnerable to cyclic fatigue. In addition, a resilient and flexible instrument reduces the risk of causing damage to the root canal wall, where there is a sharp bend in the root canal.

The endodontic instrument preferably has a tapering cutting portion and a shaft having a free end, where a grip portion that offers a grip for a hand or a tool such as a dental hand-piece is located, and the cutting portion has a plurality of primary cutting edges equiangularly spaced from one another. Suitably, the primary cutting edges are straight and preferably four in number. Preferably, the cutting portion has a basically circular cross-section, where each straight primary cutting edge is preceded by a recess extending inwards from the periphery of the circle to a section of a chord extending perpendicularly to a radius from the center of the circle to the very edge of the straight primary cutting edge. Preferably the cutting portion also includes a plurality of secondary cutting edges, which engage on the back rotation if a reciprocating hand-piece is employed. Such design provides a good number of cutting edges while not being to complex to manufacture in a MIM manufacturing process. Furthermore the design can be manufactured in a MIM process without need of subsequent cold forming techniques which may harden the instrument and increase the risk of fracture. Thus the instrument can be manufactured to have the desired hardness and yield strength.

The features specified above are applicable to an endodontic instrument irrespective of whether it is sized for the apical portion, the coronal portion, or the middle portion of a root canal.

Suitably, the endodontic instrument has a porosity of less than 10%, preferably less than 6%, a density of at least 7.4 g/cm³, and a predominantly austenitic microstructure. This gives an endodontic instrument with an excellent combination of ductility, yield strength and while in use limited risk for premature failure caused by surface defects and pores.

Such instrument can be used for cleaning apical portion of a root canal of a tooth.

We therefore provide an improved method for cleaning apical portion of a root canal of a tooth that comprises:

a) providing a metal injection molded endodontic instrument including a gripping portion configured for gripping the instrument with a hand piece, and a cutting portion sized for the apical part of the root canal, the endodontic instrument comprising in weight %:
15-30 Cr,
8-16 Ni,
0.01-5 Mo,
0.01-1 Cu,
0.09-1 Mn,
less than 0.14 C,
less than 0.12 O,
balance Fe and incidental impurities, and
   having a hardness in the range of 55-75 HRB and a yield strength in the range of 150-240 MPa;
   b) gripping the gripping portion of the endodontic instrument with a hand piece;
   c) inserting at least a part of the cutting portion in the apical part of the root canal; and
   d) powering the hand piece for cutting tissue and thereby cleaning the apical part of the root canal.

We also provide a method of cleaning a root canal of a tooth that comprises:

a) cleaning the root canal until an apical part of the root canal is reached,
b) providing a metal injection molded endodontic instrument including a gripping portion configured for gripping the instrument with a hand piece, and a cutting portion sized for the apical part of a root canal, the endodontic instrument comprising in weight %:
15-30 Cr,
8-16 Ni,
0.01-5 Mo,
0.01-1 Cu,
0.09-1 Mn,
less than 0.14 C,
less than 0.12 O,
balance Fe and incidental impurities, and
said endodontic instrument further having a hardness in the range of 55-75 HRB and a yield strength in the range of 150-240 MPa;
   c) gripping the gripping portion of the endodontic instrument with a hand piece; and
   d) powering the hand piece and advancing the cutting portion in the apical part of the root canal for cutting tissue and thereby cleaning the apical part of the root canal.

Thereby, it is possible to use a metal injection molded endodontic instrument, which can be manufactured at a much lower cost than if it should be made of a titanium-based alloy such as NiTi having super-elastic properties, and the endodontic instrument will not be rigid but have the desired flexibility, resilience and strength, and will not be likely to fail during use. NiTi is highly vulnerable to torsional stress and is also vulnerable to cyclic fatigue. In addition, a resilient and flexible instrument reduces the risk of causing damage to the root canal wall, where there is a sharp bend in the root canal.

When the root canal is cleaned using a crown down technique, the coronal part is first prepared by an instrument sized for the coronal part, and the middle part is secondly prepared by an instrument sized for the middle part, and the apical part is thirdly prepared by the instrument provided in step b) of the second embodiment of the invention.

In a preferred embodiment, the hand-piece in step d) is a reciprocating hand-piece rotating said instrument clockwise or counter-clockwise, through a first arc of rotation and, next sequentially, rotating said instrument through a second arc of rotation in a direction opposite that of the first arc of rotation. Hereby it is possible to select arcs of rotation that are smaller than those at which the endodontic instrument will not usually fracture, if bound.

In one embodiment the first arc and the second arc are of equal size. The reciprocating arc is preferably of a size that ensures that the entire circumference has been engaged by a primary or the secondary cutting edge. More, preferably the reciprocating arc should be of a size that size that ensures that the entire circumference has been engaged by a primary cutting edge. In a preferred embodiment the reciprocating arc is in the range of 60-360°, more preferably 90-120°.

In another embodiment they are of different size. If the arcs are different, each new rotation will start at a different point on the circumference, i.e. the instrument will drift slowly clockwise or anticlockwise. In such embodiment smaller arc of rotation can be used than if the first and second arcs are of equal size, since the cutting edges will work through the entire circumference due to the slowly clockwise or anticlockwise drift of the instrument. Using smaller arc of rotation may reduce the risk of the instrument becoming bound and possibly break.

In a preferred embodiment the endodontic instrument has a tapering cutting portion and a shaft having a free end, where a grip portion that offers a grip for a hand or a tool such as a dental hand-piece is located, and the cutting portion has a plurality of primary cutting edges equiangularly spaced from one another. Suitably, the primary cutting edges are straight and preferably four in number. Preferably, the cutting portion has a basically circular cross-section, where each straight cutting edge is preceded by a recess extending inwards from the periphery of the circle to a section of a chord extending perpendicularly to a radius from the center of the circle to the very edge of the straight primary cutting edge. Preferably the cutting portion also includes a plurality of secondary cutting edges, which engage on the back rotation if a reciprocating hand-piece is employed. Such design provides a good number of cutting edges while not being to complex to manufacture in a MIM manufacturing process. Furthermore the design can be manufactured in a MIM process without need of subsequent cold forming techniques which may harden the instrument and increase the risk of fracture. Thus the instrument can be manufactured to have the desired hardness and yield strength.

### BRIEF DESCRIPTION OF THE DRAWINGS

In the following, the invention will be described in more detail with reference to preferred embodiments and the appended drawings.

FIG. 1 is a side view of an endodontic instrument assembly according to a first embodiment of the present invention, including endodontic instruments of different sizes and having shafts shaped to be gripped and held by a dental hand-piece.

FIG. 2 is a top view of the endodontic instrument assembly of FIG. 1.

FIG. 3 is an end view of the endodontic instrument assembly of FIG. 1.

FIG. 4 is a side view on a larger scale of one of the endodontic instruments in the assembly of FIG. 1.

FIG. 5 is a side view on a larger scale of an alternative embodiment of one of the endodontic instruments in the assembly of FIG. 1.

FIG. 6 is a cross-sectional view on a still larger scale taken along line VI-VI in FIG. 5.

FIG. 7a, 7b shows an endodontic instrument assembly in a box.

### MODE(S) FOR CARRYING OUT THE INVENTION

The invention will be described in relation to the preferred embodiment, an endodontic instrument assembly. However, it would also be possible to produce assemblies of other medical instruments including dental and surgical instruments; for instance fastening elements used in facial surgery, orthodontic instruments, etc. Other examples of medical instruments are heart biopsy jaw, ear implants, small surgical forceps and scissors, arthroscopic surgery components, fibre optic components, dental hand tools, implantable defibrillator, heart pacemaker components, stents, valves, dental implants, ultrasonic transducers, dental orthodontic brackets, dialysis devices, and dental drills.

An endodontic instrument assembly of the present invention is made by metal injection molding and comprises at least two endodontic instruments 1, 2 and a runner 7a that interconnects the endodontic instruments and is formed integrally with them.

In injection molding, the runners, through which the molten resin or the slurry of fine metal powder and molten binder flows toward the mold chamber/chambers, will also solidify, forming an attached frame. This frame is composed of the sprue, which is the main channel from the reservoir of the resin or slurry, and runners, which are perpendicular both to the sprue and to the direction of draw (i.e. the direction in which the core and cavity separate from each other), and are used to convey the resin or slurry to the gate(s), or point(s) of injection.

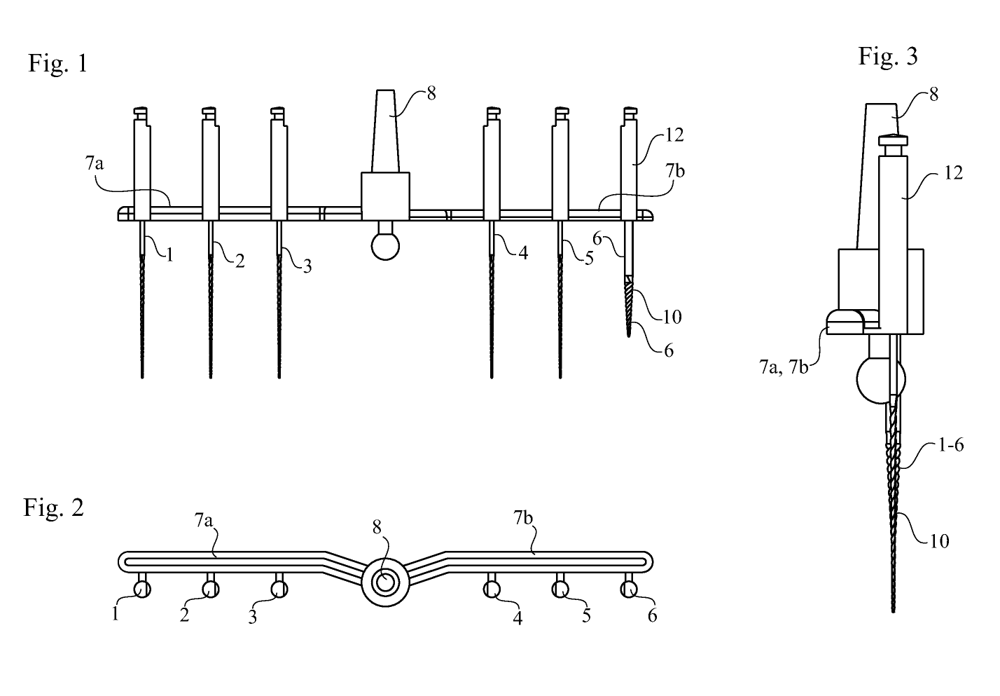

In the preferred embodiment shown in FIGS. 1-3, the assembly includes a central sprue 8, two runners 7a, 7b that are perpendicular to the sprue 8 and extend in diametrically opposite directions therefrom, and six endodontic instruments 1-6, which are attached to the runners, three endodontic instruments to each runner. The sprue 8 and the six endodontic instruments 1-6 are located essentially in a single plane, and the two runners 7a, 7b have a slight angular bend between the sprue 8 and the closest endodontic instrument 3, 4, respectively. In the preferred embodiment the six endodontic instruments 1-6 forms a set of different endodontic instruments.

Each of the endodontic instruments has a cutting portion 10 and a shaft 12. A free end of the shaft 12 has a grip portion 13-15 that offers a grip, and each of the endodontic instruments is removable from the runner 7a, 7b by breaking it away from the runner 7a, 7b, irrespective of the other. The group of six endodontic instruments 1-6 preferably is of different combination of ISO sizes and taper, e.g. a set could include the combinations 4/20, 4/25, 4/30, 6/30, 8/30, 12/30, i.e. one endodontic instrument of each combination. However, if desired, it is of course possible that two or more endodontic instruments in the group of six are of the same size and taper combination, and also that the group has fewer or more members than six. Further, it is of course possible to have taper and size combinations other than those mentioned above. Very thin endodontic instruments may be of ISO size 20, 15 or even 10, while at the opposite end of the scale, size 50 is possible. The tapering may also vary beyond 4/12.

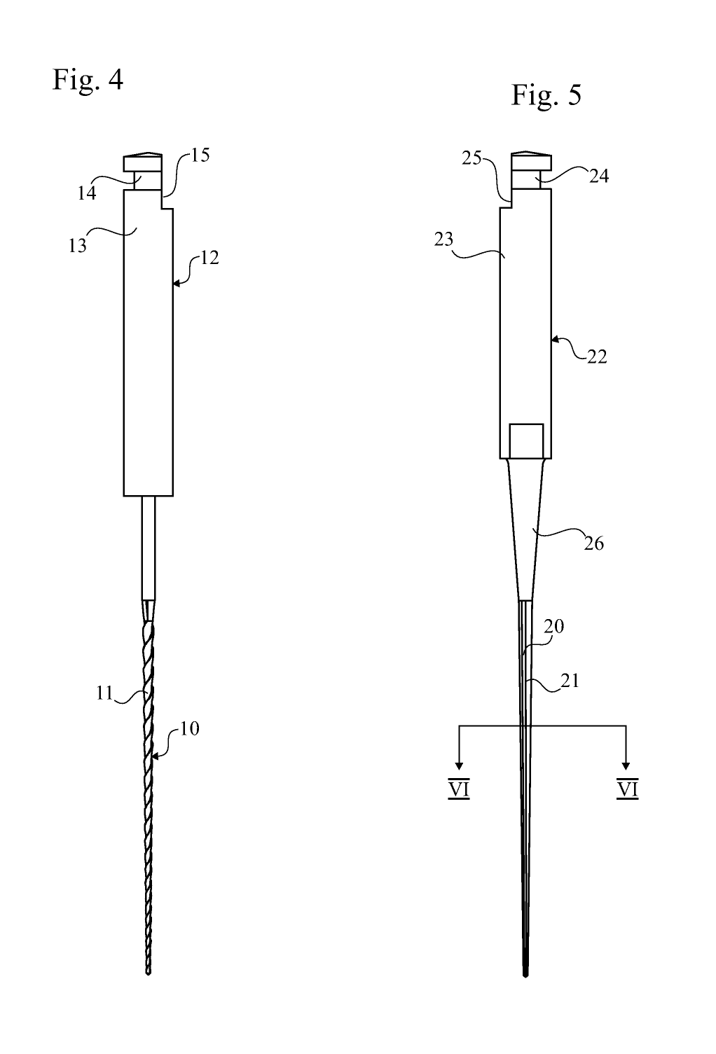

An embodiment of one of the endodontic instruments of the assembly of FIGS. 1-3 is shown in FIG. 4. The endodontic instrument has a shaft 12 that offers a grip. In the embodiment shown the shaft 12 has a free end provided with a grip portion 13-15 shaped to offer a grip to a hand-piece, not shown. As shown, the grip portion includes a head portion 13 having a neck 14 to be gripped by the hand-piece, and part of the head portion 13 is cut away to leave a surface 15 offering a rotary component in the hand-piece a grip for rotating the gripped endodontic instrument around its longitudinal axis. The hand-piece is preferably a right-angle hand-piece. The hand-piece may be of kinds rotating in a same direction at high speeds or low speeds. However, in a preferred embodiment the hand piece is of a kind being able to rotate back and forth, e.g. 90 degrees in one direction and 90 degrees back in the opposite direction; of course the angular back/forward motion could be both larger or less than 90 degrees.

Further, the endodontic instrument has a cutting portion 10 that tapers convergingly toward a free end thereof and is provided with at least one helical cutting edge 11 extending helically around the tapered cutting portion 10. The taper may be on the order of 0.02 mm/mm, for example, but larger tapers are used when practicing the crown-down method for scraping the root canal. The cutting edge 11 is formed by the cross-sectional shape of the cutting portion 10. A plurality of different cross-sectional shapes for providing the desired cutting edge are well known to a worker skilled in the art and constitute no part of the present invention. Some examples of files having different cross-sectional shapes are K-files, K-reamers, H-files and S-files. Endodontic instruments of ISO size 20 and 25 usually taper from 0.6 mm to a tip diameter of 0.20 mm and 0.25 mm, respectively. With ISO size 30 and 35, the taper usually goes from 0.7 mm to 0.30 mm and 0.35 mm, respectively, and with ISO sizes 40 and 45, the taper usually goes from 0.8 mm to 0.40 mm and 0.45 mm, respectively. The assembly of the present invention suitably comprises more than four, preferably at least six endodontic instruments 1-6 of different size. Six sizes of endodontic instruments usually are sufficient for normal endodontic therapy. Alternatively, all of the endodontic instruments of the assembly may, if desired, be of the same size.

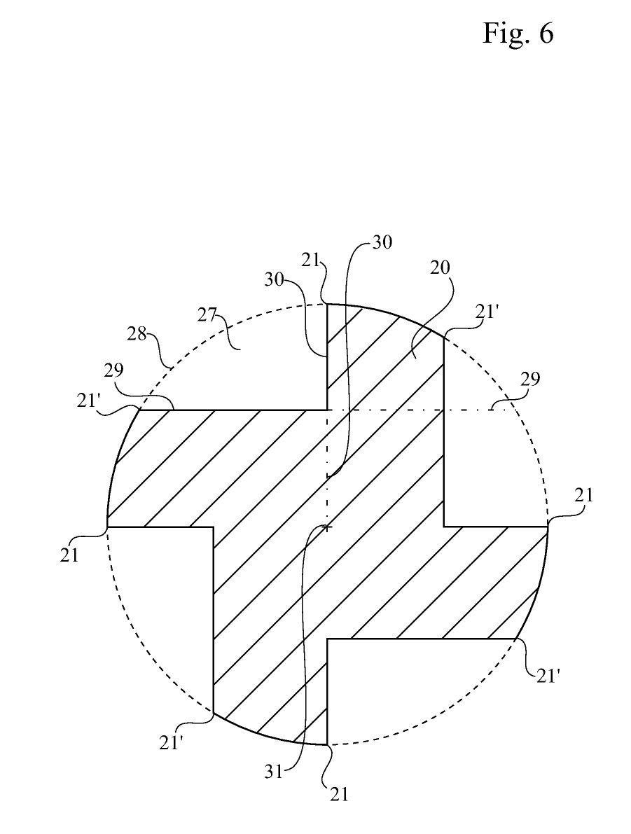

In the alternative embodiment shown in FIGS. 5 and 6, the cutting portion 20 of at least one of the endodontic instruments has a plurality of cutting edges 21, 21′ that are straight in contrast to the helical cutting edges 11 in FIGS. 1-4. The straight cutting edges 21, 21′ extend over the entire length of the cutting portion 20, and the cutting portion 20 of at least one of the endodontic instruments preferably has four straight primary cutting edges 21 equiangularly spaced from one another and four straight secondary cutting edges 21′ also equiangularly spaced from one another. Then, as illustrated in the cross-sectional view shown in FIG. 6, the cutting portion 20 has a basically circular cross-section, where each straight primary cutting edge 21 is preceded by a recess 27 extending inwards from the periphery of the circle 28 to a section of a chord 29 extending perpendicularly to a radius 30 from the center 31 of the circle to the very edge of the straight primary cutting edge 21. The four secondary cutting edges 21′ engage if the instrument is operated by a reciprocating hand-piece, i.e. when the instrument is rotated at back in an opposite rotational direction.

Further, the endodontic instrument shown in FIG. 5 has a tapered neck portion 26 interconnecting the cutting portion 20 and the shaft 22, the taper of the neck portion 26 being greater than that of the cutting portion 20. Like in the embodiment shown in FIGS. 1-4, the shaft 22 has a free end provided with a grip portion 23-25 shaped to offer a grip to a hand-piece, not shown. As shown, the grip portion includes a head portion 23 having a neck 24 to be gripped by the hand-piece, and part of the head portion 23 is cut away to leave a surface 25 offering a rotary component in the hand-piece a grip for rotating the gripped endodontic instrument around its longitudinal axis. The hand-piece is preferably a right-angle hand-piece. The hand-piece may be of kinds rotating in a same direction at high speeds or low speeds. However, in a preferred embodiment the hand-piece is of a kind being able to rotate back and forth, e.g. 90 degrees in one direction and 90 degrees back in the opposite direction; of course the angular back/forward motion could be both larger or less than 90 degrees.

Each of the endodontic instruments 1-6 is removable from the runner 7a, 7b by breaking it away from the runner, irrespective of the other endodontic instruments. Hereby, the dentist can connect the hand-piece to the shaft 12, 22 without having to touch the endodontic instrument, which reduces the risk of breaking the endodontic instrument on breaking it away from the runner 7a, 7b and attaching it to the hand-piece. Preferably, each of the endodontic instruments 1-6 is attached to the runner 7a, 7b at a position from the top of the shaft 12, 22 which is sufficient for the hand-piece to grip it, preferably at the lower part of the shaft 12, 22 (e.g. close to the lower end of the shaft 12, 22). Therefore to enable gripping by the hand-piece, the distance from top (the free end) of the shaft 12, 22 to the attachment to the runner 7a, 7b is preferably at least 5 mm, more preferably at least 10 mm. Further, the distance between two nearby endodontic instruments 1-6 on the runner 7a, 7b should be large enough to enable the hand-piece to grip the endodontic instrument 1-6 while still attached to the runner 7a, 7b. Therefore the distance between two nearby endodontic instruments 1-6 is preferably at least 4 mm, more preferably at least 6 mm, even more preferred at least 8 mm.

The shaft 12, 22 of each of the endodontic instruments 1-6 may alternatively be shaped to be gripped and held by the fingers of a user instead of by a hand-piece having the endodontic instruments spaced apart along the runner 7a, 7b, so that an arbitrary one of said shafts is readily accessible for gripping by the fingers of the user. If desired, the surface of the shaft may have the structure of a knurled surface or similar finger grip improving surface. This embodiment may be preferred by dentists who feel that their sensitivity is improved by holding the endodontic instrument between his fingers instead of holding a dental hand-piece.

However, it is a matter of course, that the special profile for the endodontic instrument that is shown in FIGS. 5 and 6 may be used also for instruments that are manufactured as individual pieces, i.e. without a runner that interconnects the endodontic instrument to another endodontic instrument.

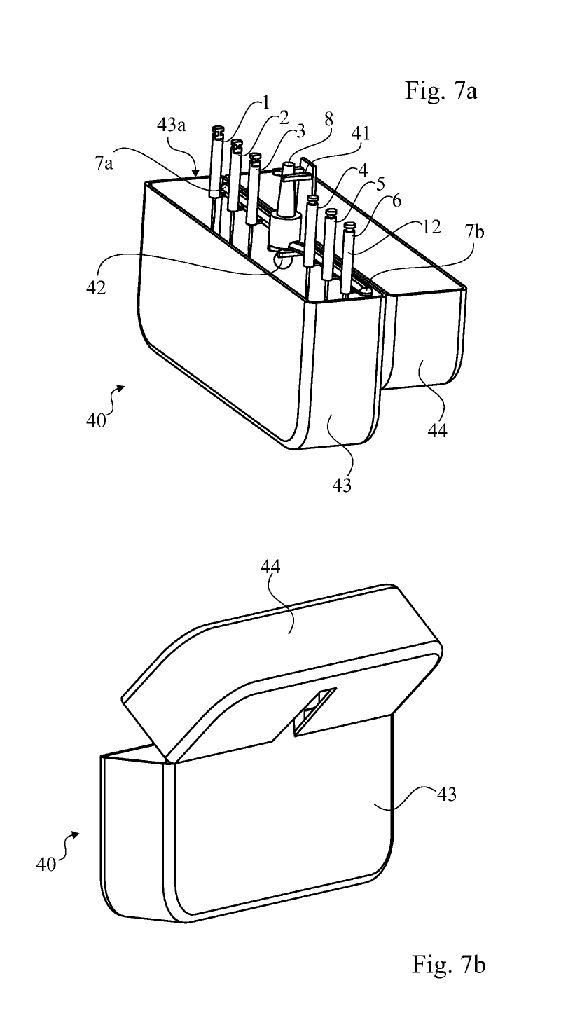

Suitably, the endodontic instrument assembly is sterilized and delivered contained in a closed sterile package/box to be opened before the eyes of a patient. FIG. 7a, 7b shows an example of such as box 40 including an endodontic instrument assembly therein. After manufacturing of the endodontic instrument assembly 1-6, 7a, 7b, 8, the assembly is placed in the box 40. The box 40 is then sealed and is sterilized together with endodontic instrument assembly, for instance by the use of gamma radiation. The box 40 includes means for securing the endodontic instrument assembly 1-6, 7a, 7b, 8 to the box, here exemplified by two gripping devices 41, 42 gripping around the upper respectively lower part of the sprue 8. The box has a bottom portion 43 and a lid portion 44, and the runners 7a, 7b are located close to the rim 43a of the bottom portion 43 so that when the lid 44 is open, the shafts 12, 22 of the endodontic instruments 1-6 are easily accessible for gripping with a hand-piece, not shown. Thereby, after opening the box 40, the dentist breaks away a suitable one of the endodontic instruments 1-6 from the runner 7a, 7b of the assembly, when using the crown-down method usually a large one for the wide entrance portion of the tapering root canal. Preferably, the endodontic instruments 1-6 of the assembly differ from each other in size, so that when the entrance portion of the root canal is treated, the dentist breaks away a thinner endodontic instrument 1-6 for treating a subsequent narrower portion of the root canal, and so on. The box 40 may also have a flange (not shown) projecting outward from the rim 43a just above the runners 7a, 7b. Thereby when the head of a hand-piece grips around one of the endodontic instruments 1-6 in the box 40 and twists it, the flange will act as a support for the runner 7a, 7b, keeping it in place as the endodontic instrument 1-6 is broken loose.

The assembly of the present invention is manufactured by metal injection molding (MIM technology). In accordance with the present invention, a medical instrument assembly, such as an endodontic instrument assembly, may be manufactured by means of MIM technology by:
a) providing a mold including a sprue 8 and at least two mold cavities (from 1-6) connected via an interconnecting runner 7a and/or 7b, each of the mold cavities at least partially corresponding to or approximating the shape of an endodontic instrument;
b) injecting a molding material including a metal powder via the sprue 8 and the runner 7a and/or 7b into the mold cavities and solidifying the molding material to form a green body including at least two connected green body portions corresponding to the mold cavities and the connective runner;
c) removing the green body from the mold,
d) optionally debinding the green body,
e) densifying the green body by sintering at a temperature above 1050° C., preferably above 1150° C., to a final density of more than 90% of the theoretical density, so as to provide a metal structure including at least two interconnected (via the sprue 8 and the runner 7a and/or 7b) endodontic instruments 1-6 corresponding to the shape of the cavities.

The assembly may be manufactured from powder of stainless steel, e.g. austenic grades such as 18/8 and hardenable stainless steel e.g. 17-4 PH, but also from powder of nickel-titanium (Ni—Ti) alloys which have good flexibility, resilience and strength. Flexibility and strength are important to avoid breakage of the endodontic instruments during the cleaning process. It is also possible to use non-nickel alloys Co—Cr or titanium or a mix of different metal powders.

Examples of suitable titanium based alloys include nickel-titanium, a nickel-titanium-chromium alloy, a nickel-titanium-copper alloy, a nickel-titanium-niobium alloy, or any other super-elastic metallic material. Titanium-based alloys are strong, yet flexible and resilient. In one embodiment, a nickel titanium alloy preferably has a titanium content in a range of about 20% to about 80%, more preferably in a range of about 30% to about 70%, and most preferably in a range of about 40% to about 60%. In another embodiment, the balance of the alloy may comprise nickel and small amounts of other ingredients which do not adversely affect the suitability of the material for use as an endodontic instrument. However, NiTi can also be vulnerable to torsional stress and to cyclic fatigue.

Therefore the preferred instrument is a metal injection molded endodontic instrument comprises in weight %:
15-30 Cr,
8-16 Ni,
0.01-5 Mo,
0.01-1 Cu,
0.09-1 Mn,
less than 0.14 C,
less than 0.12 O,
balance Fe and incidental impurities; and
in addition, it has a hardness in the range of 55-75 HRB and a yield strength in the range of 150-240 MPa.

Such a metal injection molded endodontic instrument can be manufactured at a much lower cost than if it should be made of a titanium-based alloy such as NiTi having super-elastic properties, and the endodontic instrument will not be rigid but have the desired flexibility, resilience and strength, and will not be likely to fail during use. In addition, a resilient and flexible instrument reduces the risk of causing damage to the root canal wall, where there is a sharp bend in the root canal. It can further be operated by an electrically powdered handpiece even in the apical portion of a root canal, which previously was limited to NiTi based files.

Of course such an endodontic instrument can be manufactured in an assembly as described above, or as individual pieces, i.e. without a runner that interconnects the endodontic instrument to another endodontic instrument.

The molding material can include components in addition to the metal powders.

Typically a binder is included in the molding material in order for the molded green body to more easily retain its proper shape during handling and before sintering to form the solid metal part. The binder is typically a wax or thermoplastic polymer. Those skilled in the art are familiar with the different types of binders that can be used with powdered metals. The molding material is usually a homogeneous mixture of about 60% by volume of metal powder and 40% by volume of binder, though other ratios are certainly within the scope of the invention.

The molding material is first heated until it is able to flow and is then injected into the mold cavity under relatively low pressure. The molding material then is allowed to cool, cure or otherwise solidify, until it can be ejected as a molded green body, which then is thermally processed. In one step the binder is removed by evaporation in an operation called debinding. Alternately, the molded part is immersed in a solvent to dissolve a majority of the. Once a debinded body is formed using metal injection molding, the next step is to form a solid metal part. The solid metal part is formed by sintering the body (i.e., heating the body to a temperature near the melting point of the alloy). Sintering temperatures are typically around 1200° C., but may vary depending on the particular metal, mixture of particular metals or alloy being used. The shape of the molded part is preferably retained throughout this process, and close tolerances can be achieved.

In principle, the resulting endodontic instrument assembly can be manufactured in essentially the time it takes to manufacture a single endodontic instrument by the MIM technology. Consequently, the production rate is greatly increased and the production cost greatly reduced. The piece price can be so low, that the individual endodontic instruments of an assembly are disposable, the time and effort of sterilizing used endodontic instruments is eliminated, as is the possible worry (of both patient and dentist) that a patient could get infected by an insufficiently sterilized endodontic instrument.

In accordance with an embodiment of the present invention, an improved method of cleaning an apical portion of a root canal of a tooth is achieved, in that the improved method comprises:

a) providing a metal injection molded endodontic instrument including a gripping portion configured for gripping the instrument with a hand piece, and a cutting portion sized for the apical part of the root canal, the endodontic instrument comprising in weight %:
15-30 Cr,
8-16 Ni,
0.01-5 Mo,
0.01-1 Cu,
0.09-1 Mn,
less than 0.14 C,
less than 0.12 O,
balance Fe and incidental impurities, and
having a hardness in the range of 55-75 HRB and a yield strength in the range of 150-240 MPa;
   b) gripping the gripping portion of the endodontic instrument with a hand piece;
   c) inserting at least a part of the cutting portion in the apical part of the root canal; and
   d) powering the hand piece to for cutting tissue and thereby cleaning the apical part of the root canal.

In accordance with another embodiment of the present invention, an improved method of cleaning a root canal of a tooth is achieved, in that the improved method comprises:

a) cleaning the root canal until an apical part of the root canal is reached;
b) providing a metal injection molded endodontic instrument including a gripping portion configured for gripping the instrument with a hand piece, and a cutting portion sized for the apical part of a root canal, the endodontic instrument comprising in weight %:
15-30 Cr,
8-16 Ni,
0.01-5 Mo,
0.01-1 Cu,
0.09-1 Mn,
less than 0.14 C,
less than 0.12 O,
balance Fe and incidental impurities, and
said endodontic instrument further having a hardness in the range of 55-75 HRB and a yield strength in the range of 150-240 MPa;
   c) gripping the gripping portion (23-25) of the endodontic instrument with a hand piece; and
   d) powering the hand piece and advancing the cutting portion (20) in the apical part of the root canal for cutting tissue and thereby cleaning the apical part of the root canal.

Thereby, it is possible to use a metal injection molded endodontic instrument, which can be manufactured at a much lower cost than if it should be made of a titanium-based alloy such as NiTi having super-elastic properties, and the endodontic instrument will not be rigid but have the desired flexibility, resilience and strength, and will not be likely to fail during use. In addition, a resilient and flexible instrument reduces the risk of causing damage to the root canal wall, where there is a sharp bend in the root canal.

Suitably, the endodontic instrument has a porosity of less than 10%, preferably less than 6%, a density of at least 7.4 g/cm³, and a predominantly austenitic microstructure. This gives an endodontic instrument with an excellent combination of ductility, yield strength and while in use limited risk for premature failure caused by surface defects and pores.

When the root canal is cleaned using a crown down technique, the coronal part is first prepared by an instrument sized for the coronal part, and the middle part is secondly prepared by an instrument sized for the middle part, and the apical part is thirdly prepared by the instrument provided in step b) of the second embodiment of the invention.

In a preferred embodiment, the hand-piece in step d) is a reciprocating hand-piece rotating said instrument clockwise or counter-clockwise, through a first arc of rotation and, next sequentially, rotating said instrument through a second arc of rotation in a direction opposite that of the first arc of rotation. Hereby it is possible to select arcs of rotation that are smaller than those at which the endodontic instrument will not usually fracture, if bound.

In one embodiment the first arc and the second arc are of equal size. The reciprocating arc is preferably of a size that ensures that the entire circumference has been engaged by a primary or the secondary cutting edge 21, 21′. More, preferably the reciprocating arc should be of a size that size that ensures that the entire circumference has been engaged by a primary cutting edge 21. In a preferred embodiment the reciprocating arc is in the range of 60-360°, more preferably 90-120°.

In another embodiment they are of different size. If the arcs are different, each new rotation will start at a different point on the circumference, i.e. the instrument will drift slowly clockwise or anticlockwise. In such embodiment smaller arc of rotation can be used than if the first and second arcs are of equal size, since the cutting edges will work through the entire circumference due to the slowly clockwise or anticlockwise drift of the instrument. Using smaller arc of rotation may reduce the risk of the instrument becoming bound and possibly break.

After a single use, the endodontic instruments of the present application are skewed and bent and are to be discarded. A resulting advantage is that you always have a clinically sterile instrument, and since the instruments are manufactured by MIM technology in stainless steel, they are inexpensive.

### INDUSTRIAL APPLICABILITY

The medical instrument assembly of the present invention is made by metal injection molding (MIM), and comprises at least two medical instruments that are interconnected by a runner. After being broken away from the runner by the fingers of a user or by first being attached to a tool, such as a dental hand-piece, for example, and then broken away, the medical instruments are ready to be used. In the preferred embodiment the medical instruments are endodontic instruments used by dentists and endodontists in endodontic therapy, more precisely for cleaning root canals of teeth. However, it is a matter of course, that the special profile for the endodontic instrument that has straight cutting edges may be used also for instruments that are manufactured as individual pieces, i.e. without a runner that interconnects the endodontic instrument to another endodontic instrument. Possibly, the profile with straight cutting edges may also be manufactured by other methods than metal injection moulding.

One problem with endodontic instrument manufacturing processes is that they fail to reduce or sometimes even cause stress fractures or weaknesses in the metal of the instrument, e.g. a file. Even minor imperfections in the metal of an endodontic file can be problematic. Endodontic files are very thin, thus small imperfections such as cracks can cause the file to break during use. A broken file in a root canal is very difficult to remove and can cause damage to the root canal. However, this problem is reduced by endodontic files produced by MIM manufacturing and comprising in % by weight 15-30 Cr, 8-16 Ni, 0.01-5 Mo, 0.01-1 Cu, 0.09-1 Mn, less than 0.14 C, less than 0.12 O, balance Fe and incidental impurities, and in addition, having a hardness in the range of 55-75 HRB and a yield strength in the range of 150-240 MPa. Such files will not be rigid but have the desired flexibility, resilience and strength, and will not be likely to fail during use. In addition, by using a reciprocating movement when rotating the instrument in a root canal, it is possible to reduce the stress on the instrument, and thereby minimizing the risk of fracture which can be particularly troublesome if it occurs in the apical portion of the root canal.

1. A medical instrument assembly made by metal injection molding and comprising at least two medical instruments and a runner interconnecting said at least two medical instruments and formed integrally therewith, each of said at least two medical instruments having a grip portion at a distal end that offers a grip for a hand or a tool such as a dental hand-piece, and each of said at least two medical instruments being removable from the runner by breaking it away from the runner, irrespective of the other.

2. The medical instrument assembly according to claim 1, wherein at least two of the medical instruments differ from each other.

3. The medical instrument assembly according to claim 1, comprising at least four medical instruments that differ from one another.

4. The medical instrument assembly according to claim 1, comprising at least six medical instruments that differ from one another.

5. The medical instrument assembly according to claim 1, wherein all of the medical instruments are identical.

6. The medical instrument assembly according to claim 1, wherein each of the medical instruments is a disposable one.

7. The medical instrument assembly according to claim 1, wherein said assembly being sterile and contained in a closed sterile package.

8. The medical instrument assembly according to claim 1, wherein said medical instrument assembly is a dental instrument assembly and said at least two medical instruments is at least two dental instruments.

9. The medical instrument assembly according to claim 8, wherein said dental instrument assembly is an endodontic instrument assembly and said at least two dental instruments is at least two endodontic instruments, and each of said at least two endodontic instruments having a cutting portion and a shaft having a free end, where grip portion is located.

10. The medical instrument assembly according to claim 9, wherein each of said at least two endodontic instruments is attached to the runner at a position at least 5 mm from a free end of the shaft, preferably at least 10 mm from the free end.

11. The medical instrument assembly according to claim 9, wherein the grip portion of each of said at least two endodontic instruments is shaped to be gripped and held by a dental hand-piece, and said at least two endodontic instruments are spaced apart along the runner, so that an arbitrary one of said grip portions is readily accessible for gripping by the dental hand-piece.

12. The medical instrument assembly according to claim 9, wherein the grip portion of each of said at least two endodontic instruments is shaped to be gripped and held by the fingers of a user, and said at least two endodontic instruments are spaced apart along the runner, so that an arbitrary one of said grip portions is readily accessible for gripping by the fingers of the user.

13. The medical instrument assembly according to claim 9, wherein the cutting portion of at least one of the endodontic instruments has a plurality of straight cutting edges.

14. The medical instrument assembly according to claim 13, wherein the straight cutting edges extend over the entire length of the cutting portion.

15. The medical instrument assembly according to claim 14, wherein the cutting portion of at least one of the endodontic instruments has four straight primary cutting edges equiangularly spaced from one another.

16. The medical instrument assembly according to claim 15, wherein the cutting portion has a basically circular cross-section, where each straight primary cutting edge is preceded by a recess extending inwards from the periphery of the circle to a section of a chord extending perpendicularly to a radius from the center of the circle to the very edge of the straight primary cutting edge.

17. The medical instrument assembly according to claim 16, wherein at least one of the endodontic instruments has a tapered neck portion interconnecting the cutting portion and the shaft, the taper of the neck portion being greater than that of the cutting portion.

18. The medical instrument assembly according to claim 9 wherein each endodontic instruments in the assembly differ from each other in size and/or taper.

19. A method of manufacturing a medical instrument assembly by MIM technology comprising:
a) providing a mold including a sprue and at least two mold cavities connected via an interconnecting runner, each of the mold cavities at least partially corresponding to or approximating the shape of a medical instrument;
b) injecting a molding material including a metal powder via the sprue and the runner into the mold cavities to form a green body including at least two connected green body portions corresponding to the mold cavities and the connective runner;
c) removing the green body from the mold,
d) debinding the green body, and
e) densifying the green body by sintering at a temperature above 1050° C. to a final density of more than 90% of the theoretical density, so as to provide a metal structure including at least two interconnected medical instruments corresponding to the shape of the cavities.

20. An endodontic instrument made by metal injection molding and having a tapering cutting portion and a shaft having a free end, where a grip portion that offers a grip for a hand or a tool such as a dental hand-piece is located, the cutting portion having a plurality of primary cutting edges equiangularly spaced from one another, wherein the primary cutting edges are straight and preferably four in number, and that the cutting portion has a basically circular cross-section, where each straight primary cutting edge is preceded by a recess extending inwards from the periphery of the circle to a section of a chord extending perpendicularly to a radius from the center of the circle to the very edge of the straight primary cutting edge.

21. A metal injection molded endodontic instrument comprising in weight %:
15-30 Cr,
8-16 Ni,
0.01-5 Mo,
0.01-1 Cu,
0.09-1 Mn,
less than 0.14 C,
less than 0.12 O,
balance Fe and incidental impurities; and
said endodontic instrument having a hardness in the range of 55-75 HRB and a yield strength in the range of 150-240 MPa.

22. The endodontic instrument according to claim 21, wherein the instrument has a tapering cutting portion and a shaft having a free end, where a grip portion that offers a grip for a hand or a tool such as a dental hand-piece is located, the cutting portion having a plurality of primary cutting edges equiangularly spaced from one another.

23. The endodontic instrument according to claim 22, wherein the primary cutting edges are straight.

24. The endodontic instrument according to claim 23, wherein the cutting portion has a basically circular cross-section, where each straight primary cutting edge is preceded by a recess extending inwards from the periphery of the circle to a section of a chord extending perpendicularly to a radius from the center of the circle to the very edge of the straight primary cutting edge.

25. The endodontic instrument according to claim 21, wherein the instrument is sized for the apical portion of a root canal.

26. The endodontic instrument according to claim 21, wherein the instrument is sized for the coronal portion of a root canal.

27. The endodontic instrument according to claim 21, wherein the instrument is sized for the middle portion of a root canal.

28. The endodontic instrument according to claim 21, wherein the endodontic instrument has a predominantly austenitic microstructure.

29. The endodontic instrument according to claim 21, wherein the endodontic instrument has a porosity of less than 10%.

30. The endodontic instrument according to claim 21, wherein the endodontic instrument has a porosity of less than 6%.

31. The endodontic instrument according to claim 1, wherein the endodontic instrument has a density of at least 7.4 g/cm³.

32. A method of cleaning an apical portion of a root canal of a tooth, comprising:
a) providing a metal injection molded endodontic instrument including a gripping portion configured for gripping the instrument with a hand piece, and a cutting portion sized for the apical part of the root canal, the endodontic instrument comprising in weight %:
15-30 Cr,
8-16 Ni,
0.01-5 Mo,
0.01-1 Cu,
0.09-1 Mn,
less than 0.14 C,
less than 0.12 O,
balance Fe and incidental impurities, and
having a hardness in the range of 55-75 HRB and a yield strength in the range of 150-240 MPa;
b) gripping the gripping portion of the endodontic instrument with a hand piece;
c) inserting at least a part of the cutting portion in the apical part of the root canal; and
d) powering the hand piece for cutting tissue and thereby cleaning the apical part of the root canal.

33. The method according to claim 32, wherein the root canal is cleaned using a crown down technique, where the coronal part is first prepared by an instrument sized for the coronal part, and the middle part is secondly prepared by an instrument sized for the middle part, and the apical part is thirdly prepared by the instrument provided in step a).

34. The method according to claim 32, wherein the endodontic instrument provided in step a) has a predominantly austenitic microstructure.

35. The method according to claim 32, wherein the endodontic instrument provided in step a) has a porosity of less than 10%.

36. The method according to claim 32, wherein the endodontic instrument provided in step a) has a porosity of less than 6%.

37. The method according to claim 32, wherein the endodontic instrument provided in step a) has a density of at least 7.4 g/cm³.

38. The method according to claim 32, wherein the hand-piece is a reciprocating hand-piece, and wherein in step d) the hand-piece is rotating said instrument clockwise or counter-clockwise, through a first arc of rotation and, next sequentially, rotating said instrument through a second arc of rotation in a direction opposite that of the first arc of rotation.

39. The method according to claim 32, wherein the first and the second arc are of equal size.

40. The method according to claim 32, wherein the first and the second arc are in the range of 60-360°.

41. The method according to claim 32, wherein the first and the second arc are of different size.

42. The method according to claim 32, wherein the instrument has a tapering cutting portion and a shaft having a free end, where a grip portion that offers a grip for a hand or a tool such as a dental hand-piece is located, the cutting portion having a plurality of cutting edges.

43. The method according to claim 42, wherein the cutting edges are straight.

44. A method of cleaning a root canal of a tooth, comprising:
a) cleaning the root canal until an apical part of the root canal is reached;
b) providing a metal injection molded endodontic instrument including a gripping portion configured for gripping the instrument with a hand piece, and a cutting portion sized for the apical part of a root canal, the endodontic instrument comprising in weight %:
15-30 Cr,
8-16 Ni,
0.01-5 Mo,
0.01-1 Cu,
0.09-1 Mn,
less than 0.14 C,
less than 0.12 O,
balance Fe and incidental impurities, and
said endodontic instrument further having a hardness in the range of 55-75 HRB and a yield strength in the range of 150-240 MPa;
c) gripping the gripping portion of the endodontic instrument with a hand piece; and
d) powering the hand piece and advancing the cutting portion in the apical part of the root canal for cutting tissue and thereby cleaning the apical part of the root canal.

45. The method according to claim 44, wherein the root canal is cleaned using a crown down technique, where the coronal part is first prepared by an instrument sized for the coronal part, and the middle part is secondly prepared by an instrument sized for the middle part, and the apical part is thirdly prepared by the instrument provided in step b).

46. The method according to claim 44, wherein the endodontic instrument provided in step b) has a predominantly austenitic microstructure.

47. The method according to claim 44, wherein the endodontic instrument provided in step b) has a porosity of less than 10%.

48. The method according to claim 44, wherein the endodontic instrument provided in step b) has a porosity of less than 6%.

49. The method according to claim 44, wherein the endodontic instrument provided in step b) has a density of at least 7.4 g/cm³.

50. The method according to claim 44, wherein the hand-piece is a reciprocating hand-piece, and wherein in step d) the hand-piece is rotating said instrument clockwise or counter-clockwise, through a first arc of rotation and, next sequentially, rotating said instrument through a second arc of rotation in a direction opposite that of the first arc of rotation.

51. The method according to claim 44, wherein the first and the second arc are of equal size.

52. The method according to claim 44, wherein the first and the second arc are in the range of 60-360°.

53. The method according to claim 44, wherein the first and the second arc are of different size.

54. The method according to claim 44, wherein the instrument has a tapering cutting portion and a shaft having a free end, where a grip portion that offers a grip for a hand or a tool such as a dental hand-piece is located, the cutting portion having a plurality of cutting edges.

55. The method according to claim 54, wherein the cutting edges are straight.
